(19) United States
(12) Patent Application Publication
(10) Pub. No.: US 2012/0318397 A1
(43) Pub. Date: Dec. 20, 2012

(54) CORRUGATED, OPEN-SLEEVE CONDUIT FOR USE PRINCIPALLY FOR AIRCRAFT

(75) Inventors: Franck ROUSSEAU, Truyes (FR); Yohan TENDRON, La Riche (FR)

(73) Assignee: AERAZUR, S.A., Pompidou (FR)

(21) Appl. No.: 13/494,043

(22) Filed: Jun. 12, 2012

Related U.S. Application Data
(60) Provisional application No. 61/497,164, filed on Jun. 15, 2011.

(51) Int. Cl. F16L 11/00; B29C 41/42

(52) U.S. Cl. 138/121; 264/165

(57) ABSTRACT

Conduit particularly, although not exclusively, suited for aircraft is described. The conduit may be flexible, have low bend radius achievable without twisting, and offer access along most or all of its length to wire and cable within. It also may combine open-sleeve and corrugated technologies to provide open-sleeve, corrugated textile conduit.

### CROSS-REFERENCE TO RELATED APPLICATION

This application claims the benefit of U.S. Provisional Patent Application No. 61/497,164 filed on Jun. 15, 2011, the contents of which are incorporated herein by reference.

### FIELD OF THE INVENTION

This invention relates to conduit especially—although not exclusively—useful in housing electrical wire and cable and more particularly relates to corrugated, open-sleeve conduit for use especially (although again not exclusively) for aircraft.

### BACKGROUND OF THE INVENTION

U.S. Pat. No. 6,563,045 to Goett, et al., describes various flexible, lightweight conduit developed for use principally on-board aircraft. The conduit may include an inner core of deformable tubing whose outer surface is helically corrugated. Metallized fabric, typically dispensed as tape, may be wrapped around the helical corrugations and post-formed onto the corrugated helix. The corrugated core and metallized fabric, together with other optional items, are then encased in either a solid, cylindrical protective jacket or one that itself is convoluted.

Conduit of the type discussed in the Goett patent may well protect the wires or cables housed therein. It is somewhat bulky, however, and has a relatively high bend radius. These features complicate installation of the conduit in some constrained areas, arguably reducing the overall usefulness of the conduit. Moreover, once a wire or cable is inserted into the conduit, it is accessible only at the ends of the conduit.

As used herein, “yarn” may be defined as mono- or multi-filament flexible material made of, for example, polyether ether ketone (PEEK), meta-aramid, polyphenylene sulfide (PPS), or combinations thereof “Textile,” as used herein, may refer to fabric made of multiple yarns which are knitted or woven, with at least one of the yarns being thermo-moldable.

By contrast with the conduit of the Goett patent, open-sleeve textile conduit permits access to inserted wire or cable at any point along its length. Such conduit also may have lower bend radius than the solid conduit of the Goett patent, increasing its usefulness in certain constrained regions. However, to achieve the lower bend radius, the open-sleeve textile conduit typically must be twisted during installation so as to avoid gapping of the sleeve, which twisting inhibits—if not prevents—its re-opening.

### SUMMARY OF THE INVENTION

The present invention seeks to provide textile conduit that is flexible, offers access to wire and cable housed therein along its length, and has low bend radius. The conduit further provides this low bend radius without twisting, unlike conventional open-sleeve textile conduit. It additionally maintains a generally circular cross-section in which to insert wiring and cabling.

Certain embodiments of the invention combine open-sleeve and corrugated technologies to provide open-sleeve, corrugated textile conduit. By combining flexible textiles and corrugations, bending of the conduit typically does not cause any material gapping, with the innovative conduit also reducing friction with the wires or cabling. Because of stiffness induced by the corrugations and lack of any need to twist the sleeve during installation, versions of the invention additionally may partially relieve pressure on the wire or cable bundle between clamping points.

Conduit of the present invention may be formed generally as a cylinder which is open along a longitudinal axis. The conduit closes by overwrapping itself, with the corrugations increasing friction in the overlap region to help maintain the conduit closed. The region of overlap thus has twice the thickness of other regions, as it comprises two abutting layers of material. Alternatively, material edges along the longitudinal axis may merely abut, in which case no (or essentially no) overlap exists.

Corrugations may be angled relative to a center axis of the conduit. Although no such angle is necessary in some instances, it is preferable to angle the corrugations between approximately 40-140° relative to the center axis. Moreover, corrugations may be formed in either helical or annular manner.

Manufacture of conduit of the present invention may utilize a core or die machined (or otherwise formed) with corrugations matching those of the final conduit. The die may be placed inside an uncorrugated, unformed sleeve open along a longitudinal axis. The assembly comprising the unformed sleeve and die may then be placed in a mold machined (or otherwise created) to complement the corrugations of the die, and the mold and assembly then heated and cooled for at least one cycle to form the resulting conduit. The conduit thereafter may be removed from the mold, and the die may be removed from the conduit, to prepare the conduit for use.

It thus is an optional, non-exclusive object of the present invention to provide conduit useful for housing wires, cables, and other elongated objects.

It is an additional optional, non-exclusive object of the present invention to provide flexible conduit that nonetheless permits access to its interior along its length.

It is another optional, non-exclusive object of the present invention to provide conduit with low bend radius achievable without twisting.

It is also an optional, non-exclusive object of the present invention to provide conduit that is both open sleeve and corrugated.

It is, moreover, an optional, non-exclusive object of the present invention to provide conduit whose corrugations may be angled relative to a center axis of the conduit.

It is a further optional, non-exclusive object of the present invention to provide conduit whose corrugations are either helically- or annularly-shaped and angled between 40-140° relative to the center axis.

It is yet another optional, non-exclusive object of the present invention to provide methods of making conduit in which uncorrugated, open-sleeve material is molded with a corrugated die within, with the die thereafter being removed.

Other objects, features, and advantages of the present invention will be apparent to those skilled in the relevant art with reference to the remaining text and the drawings of this application.

### BRIEF DESCRIPTION OF THE DRAWINGS

FIG. 1 is a perspective view of an exemplary conduit of the present invention.

FIG. 2A is an elevational view of a schematicized version of the conduit of FIG. 1 (without corrugations being shown).

FIG. 2B is a perspective view of the schematicized version of the conduit of FIG. 2A.

FIG. 3A is a plan view of the conduit of FIG. 1.

FIGS. 3B-D are schematicized views of alternate corrugations shapes differing from that of FIG. 3A.

FIG. 4 is a plan view of the conduit of FIG. 1 illustrating an exemplary angular orientation of the corrugations relative to a center axis of the conduit.

### DETAILED DESCRIPTION

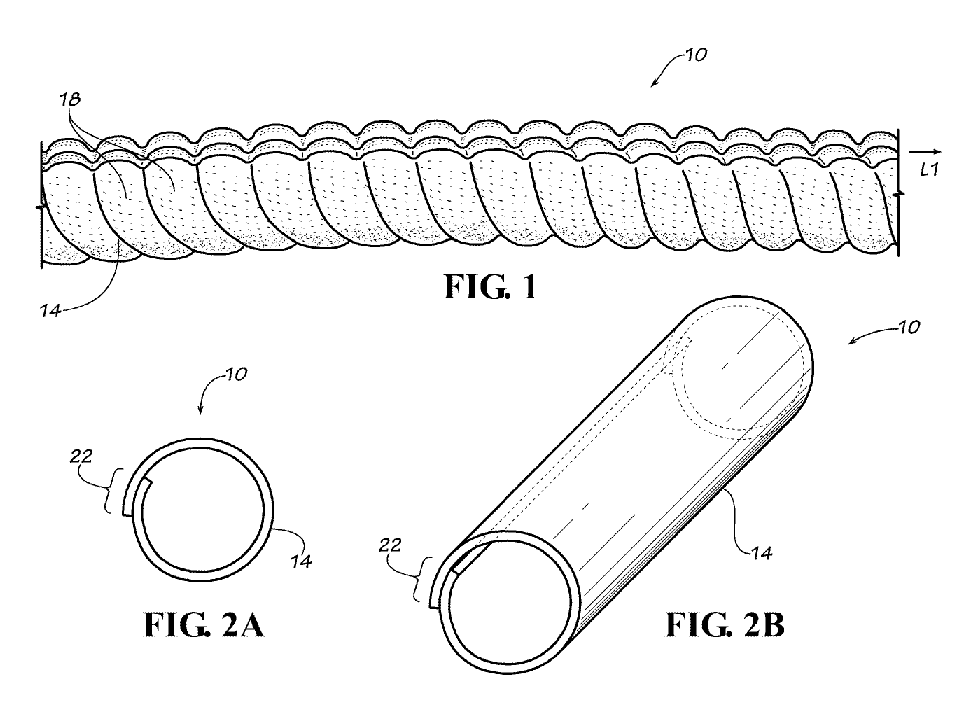

Illustrated in FIG. 1 is exemplary conduit 10 consistent with the present invention. Conduit 10 preferably comprises a generally tubular or cylindrical wall 14 that is open along a longitudinal axis L1. Wall 14 additionally preferably is corrugated, with multiple corrugations 18 existing therein. Corrugations 18 advantageously may be helically or annularly shaped, although other shapes alternatively may be employed. Conduit 10 is designed to house bundles of wires or cables, although other objects may be housed therein instead. Because wall 14 is open along axis L1, the bundles may be accessed at any point along the axis L1. Providing such access may be useful in numerous circumstances, as when repair or replacement of wires or cables, or splicing thereinto, is needed.

In FIGS. 2A-2B is shown conduit 10 in schematic form, with corrugations 18 not represented. Consistent with standard open-sleeve technology, wall 14 may overlap itself to “close” the open sleeve. Overlap region 22 thus includes two parallel, abutting layers of wall 14 and has twice the thickness of the wall 14. Boundaries of region 22 may form an angle (using a radially-central axis of wall 14 as vertex) of up to 180°, although in some versions of conduit 10 the angle preferable ranges from approximately 65-130°. As detailed especially in FIG. 2A, conduit 10 nevertheless maintains a generally circular cross-section into which wires, cables, or otherwise may be inserted. Merely by separating layers of wall 14 in overlap region 22, the inserted materials may be accessed.

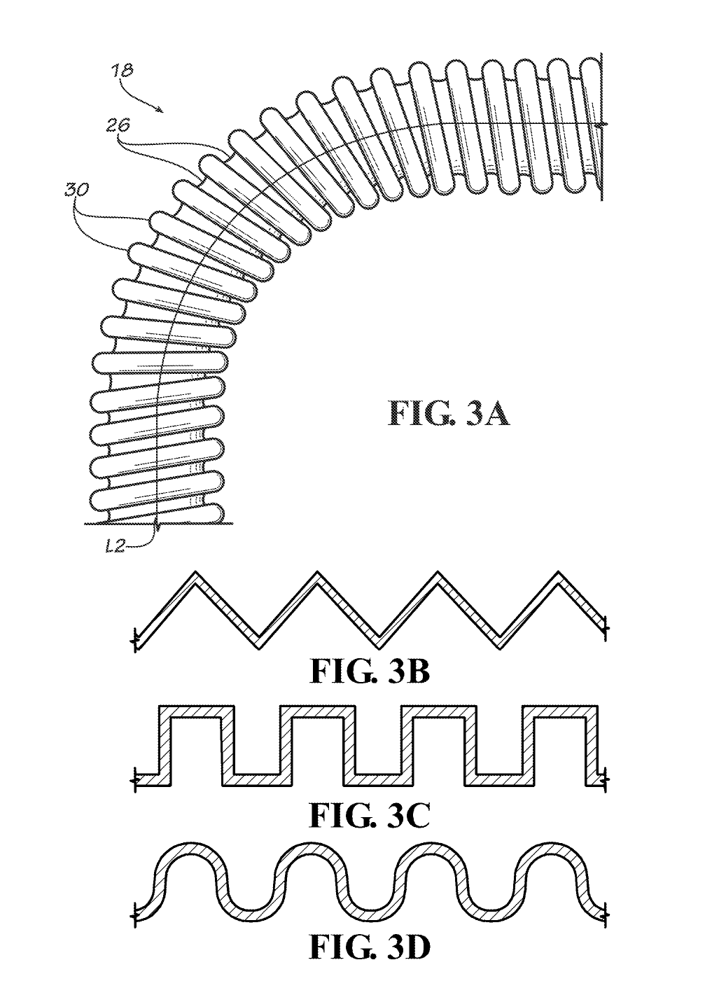

FIG. 3A details a preferred form of corrugations 18 for conduit 10. Corrugations 18 may be defined by alternating grooves 26 and ridges 30. Such grooves 26 and ridges 30 may be helical (and thus continuous over a given length of conduit 10—except at the longitudinal opening along axis L1), annular (and thus discontinuous over a given length of conduit 10), or otherwise as appropriate or desired. Grooves 26 and ridges 30 need not necessarily be shaped or configured as illustrated in FIG. 3A; instead, for example, they may form the saw-tooth shape of FIG. 3B, the square-wave shape of FIG. 3C, or the sinusoid of FIG. 3D. Indeed, persons skilled in the art will recognize that corrugations 18 may be formed or convoluted in any manner suitable for the intended function or behavior of conduit 10.

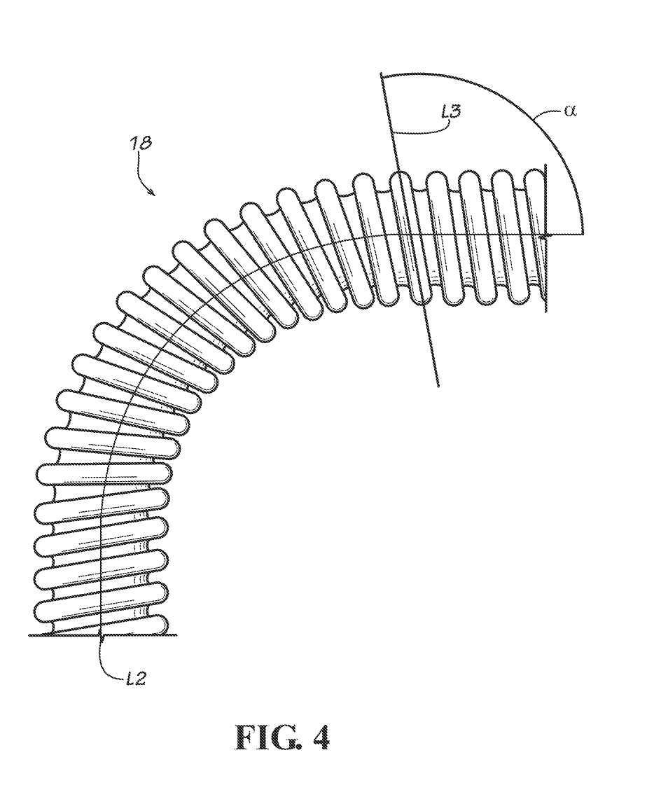

Also shown in FIG. 3A is center axis L2 of conduit 10. Because conduit 10 is bent in FIG. 3A, center axis L2 likewise is bent. Such is true for FIG. 4 as well. However, FIG. 4 additionally details an angle α relative to center axis L2. Assuming ridges 30 are formed such that each defines a central longitudinal segment L3, angle α may be defined by intersection of axis L2 and segment L3 as shown in FIG. 4. Angle α preferably ranges from 40-140° (or approximately so).

Conduit 10 may be manufactured in any appropriate manner. One manufacturing method utilizes an uncorrugated open sleeve, a corrugated die, and a mold corrugated in a manner complementary to the corrugated die. Initially, the die is placed within the open sleeve. An assembly of the die and sleeve is then placed in a mold configured to complement corrugations of the die, and the assembly and mold are heated and cooled. Following final cooling, the assembly is removed from the mold and the die is removed from the sleeve so as to form conduit 10.

Textile conduit 10 may be made of any desired material. For aircraft applications, conduit 10 preferably is made of a thermoplastic polymer or cloth (e.g., PEEK, meta-aramide, PPS, or combinations thereof), both of which are lightweight and flexible. Conduit 10 is not limited to aircraft applications, however, and instead or additionally may be deployed in any appropriate area and for any appropriate purpose.

Conduit 10 further may be made in any suitable length, and lengths of conduit 10 may be interconnected as appropriate. Metallized fabric, metal or textile braid, foil tape, shrink tubing, or any other material of the Goett patent (or otherwise) may be included as part of conduit 10 for electromagnetic protection, anti-chafing, etc. Because of its configuration, conduit 10 may have low bend radius and bend without twisting and without any material gapping of wall 14 occurring.

The foregoing is provided for purposes of illustrating, explaining, and describing embodiments of the present invention. Modifications and adaptations to these embodiments will be apparent to those skilled in the art and may be made without departing from the scope or spirit of the invention. The entire contents of the Goett patent are incorporated herein by this reference.

What is claimed is:

1. Conduit comprising a flexible wall formed generally in the shape of a cylinder, the flexible wall being (a) open along a longitudinal axis and (b) corrugated.

2. Conduit according to claim 1 in which the corrugations comprise ridges and grooves.

3. Conduit according to claim 2 defining a center axis and in which each ridge defines a central longitudinal segment forming an angle with the center axis of between approximately 40-140°.

4. Conduit according to claim 2 in which the ridges and grooves are saw-tooth shaped.

5. Conduit according to claim 2 in which the ridges and grooves form a square-wave shape.

6. Conduit according to claim 2 in which the ridges and grooves form a sinusoidal shape.

7. Conduit according to claim 1 in which the corrugations comprise helically or annularly formed ridges and grooves.

8. Conduit according to claim 1 in which the flexible wall overlaps itself to form an overlap region.

9. Conduit according to claim 1 formed of textile material comprising thermo-moldable yarn.

10. Conduit according to claim 9 in which the yarn comprises at least one of polyether ether ketone (PEEK), meta-aramid, polyphenylene sulfide (PPS), or combinations thereof.

11. Conduit according to claim 1 further comprising electromagnetic protection.

12. Aircraft comprising:
a. means for generating an electrical signal;
b. means for receiving the electrical signal; and
c. conduit for conveying the electrical signal from the generating means to the receiving means, the conduit comprising a flexible wall formed generally in the shape of a cylinder, the flexible wall being (i) open along a longitudinal axis and (ii) corrugated.

13. A method of making an open-sleeve, corrugated conduit for at least one wire or cable, comprising:
a. placing a corrugated die in an uncorrugated, open sleeve to form an assembly;
b. placing the assembly in a mold corrugated in a manner complementary to the corrugated die;
c. heating and cooling the mold and the assembly;
d. removing the assembly from the mold; and
e. removing the die from the sleeve to create the conduit.
